(19) United States
(12) Patent Application Publication
(10) Pub. No.: US 2026/0279819 A1
(43) Pub. Date: Sep. 17, 2026

(54) CONDUCTIVE PARTICLE HAVING PHOSPHORIC ACIDS FOR POSITIVE OR NEGATIVE ELECTRODE

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen, CN (CN)

(21) Appl. No.: 19/080,966

(22) Filed: Mar. 17, 2025

(51) Int. Cl. H01M 4/62; C04B 35/447; C04B 35/628; H01M 4/36

(52) U.S. Cl. CPC H01M 4/625; C04B 35/447; C04B 35/62839; C04B 35/62894; C04B 35/62897; H01M 4/366; H01M 4/628; C04B 2235/422; C04B 2235/445; C04B 2235/446; C04B 2235/447; C04B 2235/5445; C04B 2235/5454

(57) ABSTRACT

A conductive particle having phosphoric acids for a positive or negative electrode is used in a solid-state or semi-solid battery. The conductive particle includes a ceramic particle serving to guiding lithium ion passing the electrode to cause that the electrode has uniformly distributed lithium ion channels. An amorphous carbon layer is coated on an outer surface of the ceramic particle. The amorphous carbon layer has a specific conductivity to inhibit an over-expansion of a volume of the ceramic particle. A plurality of graphene sheet layers are mixed within the amorphous carbon layer. A plurality of first carbon nanotubes (CNT) are mixed within the amorphous carbon layer. The first carbon nanotube are used as bridges between the graphene sheet layers and the ceramic particle.

### FIELD OF THE INVENTION

The present invention is related to battery electrode material, and in particular to a conductive particle having phosphoric acids for a positive or negative electrode.

### BACKGROUND OF THE INVENTION

A typical battery is mainly formed by the positive and negative electrodes placed in the electrolyte. In prior arts, LLZO material is added into the electrode to increase the ion conductivity. Because LLZO material has a high lithium ion conductivity, the lithium ion channels in the electrode can be dispersed by the guiding of dispersed LLZO particles when the lithium ions pass through the electrode, resulting uniformly distributed lithium ion channels in the electrode. As a result, side reactions with the electrode slurry caused by abnormal deposition of lithium ions in the electrode slurry can be avoided.

Since moisture exists during the manufacturing process of the electrode, and the LLZO particles are hydrophilic and is easy to be dampened to form an alkali. Therefore, the LLZO particle must be coated with a protective layer to prevent the LLZO particle from being dampened during the manufacturing process. In prior arts, the LLZO particle is coated with dopamine; however dopamine has a poor electrical conductivity and reduces the electrical conductivity of electrode plates.

Based on the applicant's long experience in battery materials, the present invention would like to provide a novel design to cover the outer surface of the LLZO material with a carbon layer to make it hydrophobic so that it is less likely for water to enter the LLZO material. The carbon layer can increase the overall conductivity of the electrode particles. In addition, lithium fluoride particles are also added to the carbon layer to increase ion conductivity, and carbon nanotubes also are added to enhance the conductivity of the entire electrode, which improves the problem of volume expansion of the electrode particles and results in a higher performance of the electrode.

### SUMMARY OF THE INVENTION

Accordingly, for improving above mentioned defects in the prior art, the object of the present invention is to provide a conductive particle having phosphoric acids for a positive or negative electrode, wherein an amorphous carbon layer is coated on an outer side of the ceramic particle for inhibiting an over-expansion of a volume of the conductive particle, so as to protect the conductive particle from breakage. The amorphous carbon layer has a high conductivity and increases the electrical conductivity of the conductive particle. To avoid the difficulties of lithium-ion conduction due to excessive thickness of the amorphous carbon layer, the amorphous carbon layer further includes lithium fluoride particles which are used as bridges for the lithium ion channels to obtain a better lithium-ion conductivity.

To achieve above object, the present invention provides a conductive particle having phosphoric acids for a positive or negative electrode; the positive or negative electrode being used in a solid-state or semi-solid battery; the conductive particle comprising: a ceramic particle serving to guiding lithium ion passing the positive or negative electrode to cause that the positive or negative electrode has uniformly distributed lithium ion channels; an amorphous carbon layer coated on an outer surface of the ceramic particle; the amorphous carbon layer having a specific conductivity to inhibit an over-expansion of a volume of the ceramic particle when the ceramic particle is filled with the lithium ions; a plurality of graphene sheet layers mixed within the amorphous carbon layer; each of the graphene sheet layers having a sheet structure; the graphene sheet layers forming a multilayer structure to wrap around an outer side of the ceramic particle; and a plurality of first carbon nanotubes (CNT) mixed within the amorphous carbon layer; the first carbon nanotube being dispersed in gaps between the graphene sheet layers and the ceramic particle and in gaps between different graphene sheet layers to be used as bridges between the graphene sheet layers and the ceramic particle.

### BRIEF DESCRIPTION OF THE DRAWINGS

FIG. 1 is a cross-section view showing the structure of the conductive particle of the present invention.

FIG. 2 is another cross-section view showing the structure of the conductive particle and the lithium fluoride particles of the present invention.

FIG. 3 is a schematic view showing an application of the present invention.

FIG. 4 is a schematic view showing the composite particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

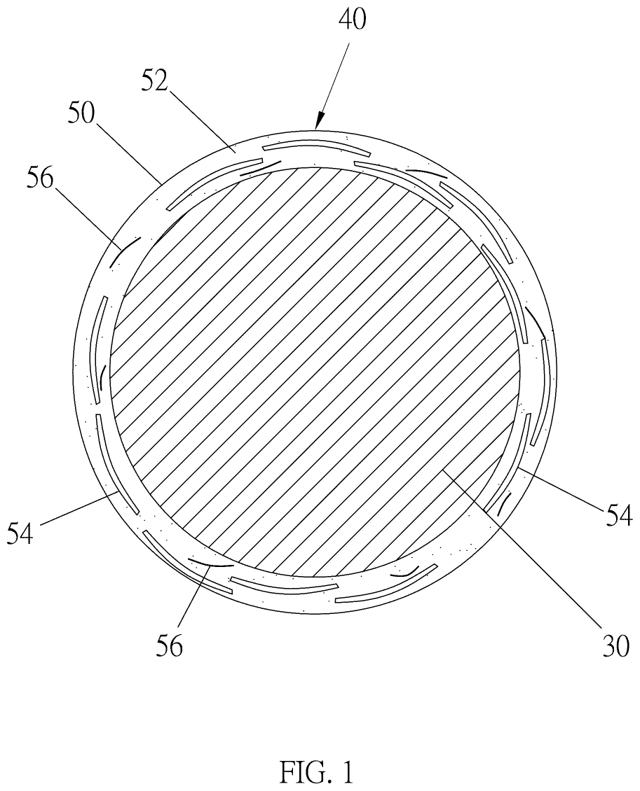

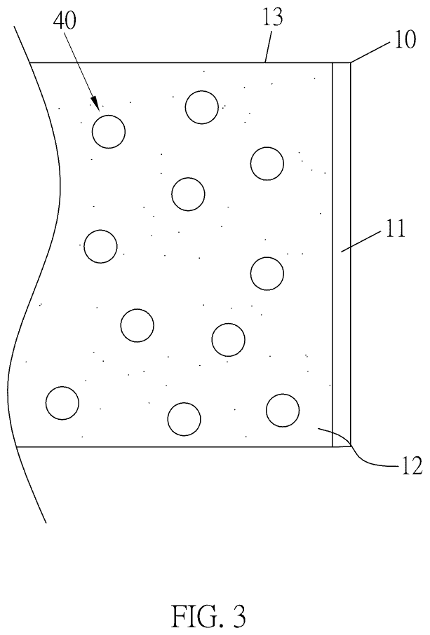

With reference to FIGS. 1 to 4, the present invention provides a conductive particle 40 having phosphoric acids for a positive or negative electrode. The conductive particle 40 is used in an electrode 10 of a solid-state or semi-solid battery. Referring to FIG. 3, the electrode 10 includes an electrode substrate 11 for carrying the material of the electrode 10, and an electrode slurry layer 13 coated on the electrode substrate 11. The electrode slurry layer 13 includes a plurality of conductive particle 40 and an electrode slurry 12 having a binder. A weight percentage of the conductive particle 40 in the electrode slurry layer 13 is 0.1 wt %~1 wt %. A particle size of each of the conductive particle 40 is less than 200 nm.

Referring to FIG. 1, the conductive particle 40 includes the following elements.

A ceramic particle 30 has a particle size less than 150 nm. The ceramic particle 30 has a high lithium ion conductivity and serves to guiding lithium ion passing the electrode 10 to disperse lithium ion channels in the electrode 10 to cause that the electrode has uniformly distributed lithium ion channels, which avoid side reactions with an electrode slurry in the electrode caused by an abnormal deposition of the lithium ions in the electrode slurry.

The ceramic particle 30 is formed by at least one of “a first ceramic oxide or phosphate capable of conducting lithium ions”, “a second oxide with a garnet structure or a perovskite structure”, and sulfide. A lithium ion conductivity of the first ceramic oxide or phosphate is higher than 10⁻³ cm²/s.

The first ceramic oxide or phosphate may be LATP (lithium aluminum titanium phosphate) with a NASICON (sodium (Na) super ionic conductor) structure, LAGP (lithium aluminium germanium phosphate), or lithiophosphate (Li₃PO₄). The second oxide may be LLZO (Li₇La₃Zr₂O_{12 ,} lithium lanthanum zirconium oxide) or LLTO (lithium lanthanum titanium oxide). The sulfide may be LGPS (lithium germanium phosphorus sulfide). The ceramic particle 30 can be formed by combination of above materials with any ratio.

The ceramic particle 30 can be formed by at least one of LLZO (Li₇La₃Zr₂O₁₂), Ga-LLZO (gallium-doped LLZO), Cu-LLZO (copper-doped LLZO), Ta-LLZO (tantalum-doped LLZO), Sr-LLZO (strontium-doped LLZO) and Al-LLZO (aluminum-doped LLZO).

When the ceramic particle 30 is formed by LAGP or LATP, the LAGP or LATP is selected from Li₁₊ₓAlₓA₂₋ₓ(PO₄)₃ or Li_{1+x+y}AlₓA_{2-x-y-z}M_{y}N_{z}(PO₄)₃, wherein 0.1≤x≤0.8, 0≤y≤0.2, 0≤z≤0.2, A is germanium (Ge) or titanium (Ti), M is trivalent cation (such as scandium cation (Sc³⁺), yttrium cation (Y³⁺), gallium cation (Ga³⁺), indium cation (In³⁺) or lanthanum cation (La³⁺)), and N is tetravalent cation (such as zirconium cation (Zr⁴⁺), silicon cation (Si⁴⁺), or tin cation (Sn⁴⁺)).

An amorphous carbon layer 50 is coated on an outer surface of the ceramic particle 30. A radial thickness of the amorphous carbon layer 50 is less than 10 nm. The amorphous carbon layer 50 has a high conductivity to inhibit an over-expansion of a volume of the ceramic particle 30 when the ceramic particle 30 is filled with the lithium ions, so as to protect the conductive particle 40 from breakage.

The amorphous carbon layer 50 includes amorphous carbons 52. The amorphous carbons 52 are formed by at least one of:
(i) hard carbons or soft carbons formed by a de-esterification in sintering of organic resins or organic carbohydrates.
(ii) amorphous carbons formed by a reaction of an organic compound under a reduction atmosphere. The organic compound is selected from carbohydrate (such as monosaccharide, disaccharide, oligosaccharide or polysaccharide), water-soluble fiber and amino acid polymer. Preferably, the organic compound is a carbon-contained compound having at least one of nitrogen, fluorine, phosphorus and sulfur. The nitrogen, fluorine, phosphorus and sulfur are doped to the carbon by a reduction reaction, which increases the electrical conductivity of the conductive particle 40.
(iii) Amorphous Carbons Formed by a Dehydration of carbohydrates.
(iv) amorphous carbons having carbon skeletons and functional groups formed by a dehydration of water-soluble fibers.
(v) amorphous carbons having carbon skeletons with straight chains or side chains containing doping elements, formed by a dehydration of amino acid polymers.

A plurality of graphene sheet layers 54 are mixed within the amorphous carbon layer 50. Each of the graphene sheet layers 54 is a few-layer graphene (FLG) having 2~10 graphene layers. A size of each of the graphene sheet layers 54 is less than 500 nm. Each of the graphene sheet layers 54 has a sheet structure. The graphene sheet layers 54 form a multilayer structure to wrap around an outer side of the ceramic particle 30.

A plurality of first carbon nanotubes (CNT) 56 are mixed within the amorphous carbon layer 50. Each of the first carbon nanotubes 56 has a length less than 1 μm. The first carbon nanotube 56 are dispersed in gaps between the graphene sheet layers 54 and the ceramic particle 30 and in gaps between different graphene sheet layers 54 to be used as bridges between the graphene sheet layers 54 and the ceramic particle 30, which increases the conductivity of the conductive particle 40.

A ratio of a weight of the ceramic particle 30 and a weight of the amorphous carbon layer 50 is 99.5:0.5. A ratio of a total weight of the graphene sheet layers 54 and a total weight of the first carbon nanotube 56 is 4:1.

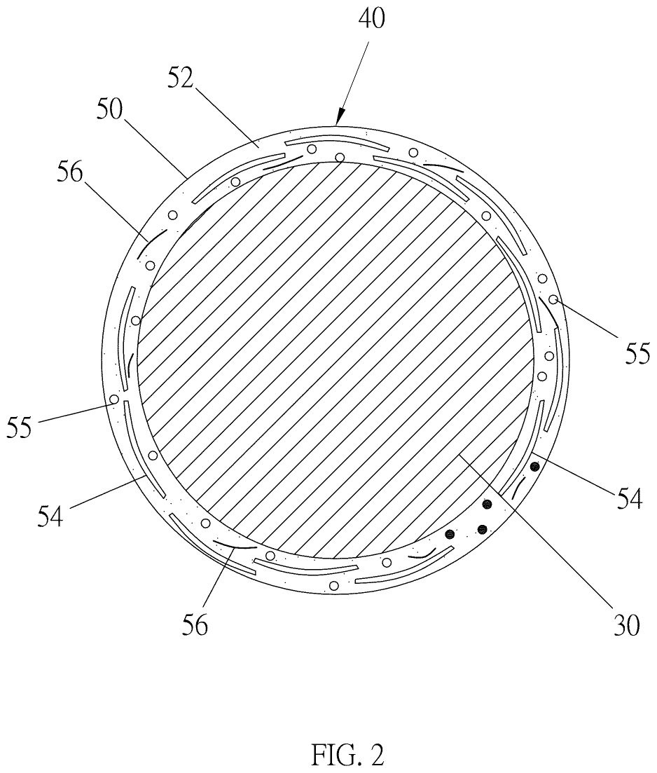

Referring to FIG. 2, the present invention further includes:

A plurality of lithium fluoride (LiF) particles 55 are dispersed within the amorphous carbon layer 50. Since the efficiency of passage of the lithium ions through the conductive particle 40 is affected by the thickness of the amorphous carbon layer 50, the lithium fluoride particles 55 can be used as bridges to guiding the lithium ions through the conductive particle 40. The lithium fluoride (LiF) particles 55 form a plurality of island-shaped structure.

A particle size of each of the lithium fluoride particles 55 is less than 5 nm. A ratio of a weight of the ceramic particle 30 and a total weight of the lithium fluoride particles 55 is 99.9~99.95:0.1~0.05.

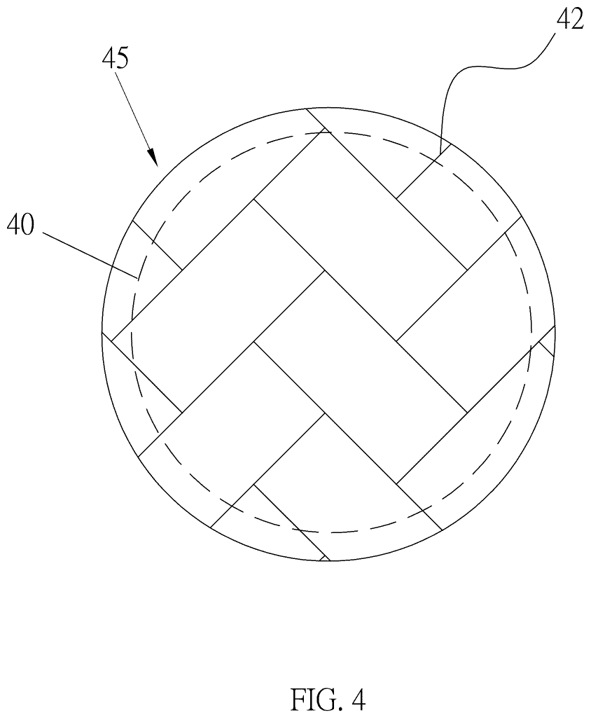

Referring to FIG. 4, an outer side of the conductive particle 40 is further coated with a plurality of second carbon nanotubes 42 to form a composite particle 45. Each of the second carbon nanotubes 42 has a length between 1~3 μm.

Carbon nanotubes have a high conductivity. The composite particle 45 has a yarn-ball-like structure. The second carbon nanotubes 42 serve to enhance the electrical conductivity to cause that the electrons can be conducted on the conductive particle 40. The second carbon nanotubes 42 further serve to conducting the lithium ions to cause that the lithium ions can be conducted between different conductive particle 40 in the electrode 10, which increases the electrical conductivity and ion conductivity of the electrode 10.

A ratio of a total weight of the second carbon nanotubes 42 and a weight of the conductive particle 40 is 1:99 to 0.2:99.8.

The advantages of the present invention are that an amorphous carbon layer is coated on an outer side of the ceramic particle for inhibiting an over-expansion of a volume of the conductive particle, so as to protect the conductive particle from breakage. The amorphous carbon layer has a high conductivity and increases the electrical conductivity of the conductive particle. To avoid the difficulties of lithium-ion conduction due to excessive thickness of the amorphous carbon layer, the amorphous carbon layer further includes lithium fluoride particles which are used as bridges for the lithium ion channels to obtain a better lithium-ion conductivity.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A conductive particle having phosphoric acids for a positive or negative electrode; the positive or negative electrode being used in a solid-state or semi-solid battery; the conductive particle comprising:
a ceramic particle serving to guiding lithium ion passing the positive or negative electrode to cause that the positive or negative electrode has uniformly distributed lithium ion channels;
an amorphous carbon layer coated on an outer surface of the ceramic particle; the amorphous carbon layer having a specific conductivity to inhibit an over-expansion of a volume of the ceramic particle when the ceramic particle is filled with the lithium ions;
a plurality of graphene sheet layers mixed within the amorphous carbon layer; each of the graphene sheet layers having a sheet structure; the graphene sheet layers forming a multilayer structure to wrap around an outer side of the ceramic particle; and
a plurality of first carbon nanotubes (CNT) mixed within the amorphous carbon layer; the first carbon nanotube being dispersed in gaps between the graphene sheet layers and the ceramic particle and in gaps between different graphene sheet layers to be used as bridges between the graphene sheet layers and the ceramic particle.

2. The conductive particle having the phosphoric acids for the positive or negative electrode as claimed in claim 1, further comprising a plurality of lithium fluoride (LiF) particles are dispersed within the amorphous carbon layer; wherein the lithium fluoride particles is used as bridges to guiding the lithium ions through the conductive particle; and the lithium fluoride (LiF) particles form a plurality of island-shaped structure.

3. The conductive particle having the phosphoric acids for the positive or negative electrode as claimed in claim 1, wherein the ceramic particle is formed by at least one of “a first ceramic oxide or phosphate capable of conducting lithium ions”, “a second oxide with a garnet structure or a perovskite structure”, and sulfide; and a lithium ion conductivity of the first ceramic oxide or phosphate is higher than 10⁻³ cm²/s.

4. The conductive particle having the phosphoric acids for the positive or negative electrode as claimed in claim 3, wherein the first ceramic oxide or phosphate is selected from LATP (lithium aluminum titanium phosphate) with a NASICON (sodium (Na) super ionic conductor) structure, LAGP (lithium aluminium germanium phosphate), lithiophosphate (Li₃PO₄).

5. The conductive particle having the phosphoric acids for the positive or negative electrode as claimed in claim 4, wherein the ceramic particle is formed by LAGP or LATP, the LAGP or LATP is selected from Li₁₊ₓAlₓA₂₋ₓ(PO₄)₃ or Li_{1+x+y}AlₓA_{2-x-y-z}M_{y}N_{z}(PO₄)₃, wherein 0.1≤x≤0.8, 0≤y≤0.2, 0≤z≤0.2, A is germanium (Ge) or titanium (Ti), M is trivalent cation, and N is tetravalent cation.

6. The conductive particle having the phosphoric acids for the positive or negative electrode as claimed in claim 5, wherein M is selected from scandium cation (Sc³⁺), yttrium cation (Y³⁺), gallium cation (Ga³⁺), indium cation (In³⁺) and lanthanum cation (La³⁺).

7. The conductive particle having the phosphoric acids for the positive or negative electrode as claimed in claim 5, wherein N is selected from zirconium cation (Zr⁴⁺), silicon cation (Si⁴⁺), and tin cation (Sn⁴⁺).

8. The conductive particle having the phosphoric acids for the positive or negative electrode as claimed in claim 2, wherein a particle size of each of the lithium fluoride particles is less than 5 nm; and a ratio of a weight of the ceramic particle and a total weight of the lithium fluoride particles is 99.9~99.95:0.1~0.05.

9. The conductive particle having the phosphoric acids for the positive or negative electrode as claimed in claim 1, wherein a radial thickness of the amorphous carbon layer is less than 10 nm; and a particle size of the conductive particle is less than 200 nm.

10. The conductive particle having the phosphoric acids for the positive or negative electrode as claimed in claim 1, wherein the ceramic particle has a particle size less than 150 nm.

11. The conductive particle having the phosphoric acids for the positive or negative electrode as claimed in claim 1, wherein the amorphous carbon layer includes amorphous carbons; and the amorphous carbons are formed by at least one of:
(a) hard carbons or soft carbons formed by a de-esterification in sintering of organic resins or organic carbohydrates;
(b) amorphous carbons formed by a reaction of an organic compound under a reduction atmosphere;
(c) amorphous carbons formed by a dehydration of carbohydrates;
(d) amorphous carbons having carbon skeletons and functional groups formed by a dehydration of water-soluble fibers; and
(e) amorphous carbons having carbon skeletons with straight chains or side chains containing doping elements, formed by a dehydration of amino acid polymers.

12. The conductive particle having the phosphoric acids for the positive or negative electrode as claimed in claim 11, wherein the organic compound is carbohydrate which is selected from monosaccharide, disaccharide, oligosaccharide, polysaccharide, water-soluble fiber and amino acid polymer.

13. The conductive particle having the phosphoric acids for the positive or negative electrode as claimed in claim 11, wherein the organic compound is a carbon-contained compound having at least one of nitrogen, fluorine, phosphorus and sulfur.

14. The conductive particle having the phosphoric acids for the positive or negative electrode as claimed in claim 1, wherein each of the graphene sheet layers is a few-layer graphene (FLG) having 2~10 graphene layers; each of the graphene sheet layers has a sheet structure; and a size of each of the graphene sheet layers is less than 500 nm.

15. The conductive particle having the phosphoric acids for the positive or negative electrode as claimed in claim 1, wherein each of the first carbon nanotubes has a length less than 1 μm.

16. The conductive particle having the phosphoric acids for the positive or negative electrode as claimed in claim 1, wherein a ratio of a weight of the ceramic particle and a weight of the amorphous carbon layer is 99.5:0.5; and a ratio of a total weight of the graphene sheet layers and a total weight of the first carbon nanotube is 4:1.

17. The conductive particle having the phosphoric acids for the positive or negative electrode as claimed in claim 1, wherein an outer side of the conductive particle is further coated with a plurality of second carbon nanotubes to form a composite particle; the composite particle has a yarn-ball-like structure; and the second carbon nanotubes serve to increase the electrical conductivity of the positive or negative electrode.

18. The conductive particle having the phosphoric acids for the positive or negative electrode as claimed in claim 17, wherein each of the second carbon nanotubes has a length between 1~3 μm; and a ratio of a total weight of the second carbon nanotubes and a weight of the conductive particle is 1:99 to 0.2:99.8.
